(19) United States
(12) Patent Application Publication
(10) Pub. No.: US 2018/0117950 A1
(43) Pub. Date: May 3, 2018

(54) A SECURITY DOCUMENT OR TOKEN

(71) Applicant: CCL SECURE PTY LTD, Craigieburn, Victoria (AU)

(72) Inventor: Gary Fairless Power, Craigieburn, Victoria (AU)

(73) Assignee: CCL SECURE PTY LTD, Craigieburn, Victoria (AU)

(21) Appl. No.: 15/561,859

(22) PCT Filed: Mar. 24, 2016
(86) PCT No.: PCT/AU2016/050218

§ 371 Date: Sep. 26, 2017

(30) Foreign Application Priority Data
Mar. 26, 2015 (AU) 2015100387
Mar. 26, 2015 (AU) 2015901101

(51) Int. Cl. B42D 25/351; B42D 25/355; B42D 25/45; B42D 25/378

(52) U.S. Cl. CPC B42D 25/351; B42D 25/355; B42D 25/29; B42D 25/378; B42D 25/45

(57) ABSTRACT

The invention relates to a security document 10 and a method of making the security document 10. The security document 10 has an optically transmissive region with a first surface and a second surface on an opposite side to the first surface. On a portion of the first surface is a first opacifying layer 14, with an area B of the optically transmissive region not being covered by the first opacifying layer 14. Similarly, on a portion of the second surface is a second opacifying layer 16, with an area A of the optically transmissive region not being covered by the second opacifying layer 16. The uncovered area B of the first surface does not substantially overlap the uncovered area A of the second surface. Further, the uncovered area B of the first surface and uncovered area A of the second surface appear to be substantially contiguous when viewed in transmitted light.

### FIELD OF THE INVENTION

The present invention relates to a security document or token, such as banknotes or the like, and is particularly, but not exclusively, concerned with providing a security document with an enhanced security device.

### BACKGROUND OF THE INVENTION

Australian patent specification AU-A-87665/82 describes a security document and a method of making a security document in which opacifying layers are applied to both sides of plastic film substrate. The security document is produced with areas where no opacifying ink is applied on both sides of the substrate to form ‘windows’, in which a security device can be incorporated. A disadvantage with the security document of this patent is that the security device on the window can be tampered with.

Australian patent specification 199741934 describes applying an opacifying layer to one surface of a window to form a partly transparent or translucent window, or a ‘half-window’. In this arrangement, the security device is provided between the opacifying layer and the substrate. The security device in the half-window cannot be easily tampered with because the security device is between the substrate and an opacifying layer. A disadvantage with the security document of this patent is that the security device of the window cannot be seen, or is at least only barely visible in transmitted light, when viewed from the other side.

There is a need to provide a security document with an improved security device or feature, and/or to at least provide the public with a useful choice.

### BRIEF SUMMARY OF THE INVENTION

According to one aspect, the present invention provides a method of manufacturing a security document, the method comprising the steps of: providing an optically transmissive region;

applying a first opacifying layer on a portion of a first surface of the optically transmissive region with an area on the first surface of the optically transmissive region not being covered by the first opacifying layer; and
applying a second opacifying layer on a portion of a second surface of the optically transmissive region, the second surface being on an opposite side of the optically transmissive region to the first surface, with an area on the second surface of the optically transmissive region not being covered by the second opacifying layer;
wherein the uncovered area of the first surface does not substantially overlap the uncovered area of the second surface, and the uncovered area of the first surface and uncovered area of the second surface appear to be substantially contiguous when viewed in transmitted light.

In an embodiment, the security document is a banknote. In an additional or alternative embodiment, the security document is one or more of a credit card; cheque; passport; identity card; security and share certificate; driver's license; deed of title; travel document; entrance document, birth, death or marriage certificate; and academic transcript.

In an embodiment, the method further comprises providing the optically transmissive region in a substrate. In an embodiment, the entire substrate is optically transmissive. The substrate is preferably formed from one or more of polypropylene (PP), polyethylene (PE), polycarbonate (PC), polyvinyl chloride (PVC), polyethylene terephthalate (PET), biaxially-oriented polypropylene (BOPP).

In an embodiment, the substrate comprises optically opaque regions and one or more optically transmissive regions. The substrate is preferably formed from a substantially opaque material, such as paper or fibrous material, with an optically transmissive material inserted into a cut-out, or recess in the paper or fibrous substrate. In an embodiment, the optically transmissive material is one or more inserts of transparent plastics material.

In an embodiment, the method further comprises providing a security device on or in the optically transmissive region, a portion of the security device being viewable through the uncovered area on the first surface against the opacifying layer on the second surface and a different portion of the security device being viewable through the uncovered area on the second surface against the opacifying layer on the first surface. The security device may extend to areas of the substrate that are the covered by the opacifying layer. Portions of the security device that extend to areas of the substrate that are covered by the opacifying layer are preferably more visible in transmitted light than in reflected light. The security device may be applied to the first and/or second surfaces of the substrate.

In an embodiment, the method further comprises providing a first security device on or in the optically transmissive region that is viewable through the uncovered area on the first surface. In one embodiment, the method further comprises providing a second security device on or in the optically transmissive region that is viewable through the uncovered area on the second surface. In one embodiment, the first security device and the second security device are of the same type. In an alternative embodiment, the first security device is different from the second security device.

In an embodiment, the security device that is viewable through the uncovered area on the first surface is sandwiched between the optically transmissive region and the opacifying layer on the second surface. In an alternative embodiment, the security device that is viewable through the uncovered area on the first surface is on the uncovered area of the first surface.

In an embodiment, the security device that is viewable through the uncovered area on the second surface is sandwiched between the optically transmissive region and the opacifying layer on the first surface. In an alternative embodiment, the security device that is viewable through the uncovered area on the second surface is on the uncovered area of the second surface.

In an embodiment, the security device comprises one or more of a security thread; fluorescent, luminescent and phosphorescent inks; metallic inks; iridescent inks; photochromic, thermochromic, hydrochromic or piezochromic inks; printed and embossed features, including relief structures; interference layers; liquid crystal devices; lenses and lenticular structures; and/or optically variable devices (OVDs) such as diffractive devices including diffraction gratings, holograms and diffractive optical elements (DOEs).

In an embodiment, the first surface of the optically transmissive region comprises more than one area that is not covered by the first opacifying layer. In an embodiment, the second surface of the optically transmissive region comprises more than one area that is not covered by the opacifying layer. Where the first and/or second surfaces comprise more than one uncovered area, the uncovered area(s) of the first surface does not substantially overlap the uncovered area(s) of the second surface. Where the first and/or second surfaces of the substrate comprise more than one uncovered area, the uncovered area(s) of the first surface and uncovered area(s) of the second surface appear to be substantially contiguous when viewed in transmitted light.

In an embodiment, the uncovered area(s) of the first surface and the uncovered area(s) of the second surface appear to be substantially contiguous when viewed in transmitted light within a range of predefined viewing angles. Preferably, the predefined viewing angle includes a viewing angle that is at substantially a normal to the first and second surfaces. The range of predefined viewing angles is preferably between about −60° and about +60° to the normal of the first and second surfaces. More preferably, the range of predefined viewing angles is between about −45° and about +45° to the normal of the first and second surfaces. Even more preferably, the range of predefined viewing angles is between about −10° and about +10° to the normal of the first and second surfaces.

According to another aspect, the present invention provides a security document when manufactured by the method of the present invention.

According to a further aspect, the present invention provides a security document comprising:

an optically transmissive region having first and second surfaces on opposite sides of the optically transmissive region,
a first layer of opacifying ink on a portion of the first surface of the optically transmissive region, with an area of the optically transmissive region on the first surface not being covered by the first layer of opacifying ink, and
a second layer of opacifying ink on a portion of the second surface of the optically transmissive region, with an area of the optically transmissive region on the second surface not being covered by the second layer of opacifying ink,
wherein the uncovered area of the first surface does not substantially overlap the uncovered area of the second surface, and the uncovered area of the first surface and uncovered area of the second surface appear to be substantially contiguous when viewed in transmitted light.

In an embodiment, the security document is a banknote. In an additional or alternative embodiment, the security document is one or more of a credit card; cheque; passport; identity card; security and share certificate; driver's license; deed of title; travel document; entrance document, birth, death or marriage certificate; and academic transcript.

In an embodiment, the optically transmissive region is provided in or part of a substrate. In an embodiment, the entire substrate is optically transmissive. The substrate is preferably formed from one or more of polypropylene (PP), polyethylene (PE), polycarbonate (PC), polyvinyl chloride (PVC), polyethylene terephthalate (PET), biaxially-oriented polypropylene (BOPP).

In an embodiment, the substrate comprises optically opaque regions and one or more optically transmissive regions. The substrate is preferably formed from a substantially opaque material, such as paper or fibrous material, with an optically transmissive material inserted into a cut-out, or recess in the paper or fibrous substrate. In an embodiment, the optically transmissive material is one or more inserts of transparent plastics material.

In an embodiment, the security document comprises a security device on or in the optically transmissive region, a portion of the security device being viewable through the uncovered area on the first surface against the opacifying layer on the second surface and a different portion of the security device being viewable through the uncovered area on the second surface against the opacifying layer on the first surface. The security device may extend to areas of the substrate that are the covered by the opacifying layer. Portions of the security device that extend to areas of the substrate that are covered by the opacifying layer are preferably more visible in transmitted light than in reflected light. The security device may be applied to the first and/or second surfaces of the substrate.

In an embodiment, the security document comprises a first security device on or in the optically transmissive region that is viewable through the uncovered area on the first surface. In one embodiment, the security document further comprises a second security device on or in the optically transmissive region that is viewable through the uncovered area on the second surface. In one embodiment, the first security device and the second security device are of the same type. In an alternative embodiment, the first security device is different from the second security device.

In an embodiment, the security device that is viewable through the uncovered area on the first surface is sandwiched between the optically transmissive region and the opacifying layer on the second surface. In an alternative embodiment, the security device that is viewable through the uncovered area on the first surface is on the uncovered area of the first surface.

In an embodiment, the security device that is viewable through the uncovered area on the second surface is sandwiched between the optically transmissive region and the opacifying layer on the first surface. In an alternative embodiment, the security device that is viewable through the uncovered area on the second surface is on the uncovered area of the second surface.

In an embodiment, the security device comprises one or more of a security thread; fluorescent, luminescent and phosphorescent inks; metallic inks; iridescent inks; photochromic, thermochromic, hydrochromic or piezochromic inks; printed and embossed features, including relief structures; interference layers; liquid crystal devices; lenses and lenticular structures; and/or optically variable devices (OVDs) such as diffractive devices including diffraction gratings, holograms and diffractive optical elements (DOEs).

In an embodiment, the first surface of the optically transmissive region comprises more than one area that is not covered by the first opacifying layer. In an embodiment, the second surface of the optically transmissive region comprises more than one area that is not covered by the opacifying layer. Where the first and/or second surfaces of the substrate comprise more than one uncovered area, the uncovered area(s) of the first surface does not substantially overlap the uncovered area(s) of the second surface. Where the first and/or second surfaces of the substrate comprise more than one uncovered area, the uncovered area(s) of the first surface and uncovered area(s) of the second surface appear to be substantially contiguous when viewed in transmitted light.

In an embodiment, the uncovered area(s) of the first surface and the uncovered area(s) of the second surface appear to be substantially contiguous when viewed in transmitted light within a range of predefined viewing angles. Preferably, the predefined viewing angle includes a viewing angle that is at substantially a normal to the first and second surfaces. The range of predefined viewing angles is preferably between about −60° and about +60° to the normal of the first and second surfaces. More preferably, the range of predefined viewing angles is between about −45° and about +45° to the normal of the first and second surfaces. Even more preferably, the range of predefined viewing angles is between about −10° and about +10° to the normal of the first and second surfaces.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

As used herein, the term ‘comprising’ means ‘including’ or ‘consisting at least in part of’. When interpreting statements, including claims, in this specification that include the term ‘comprising’, features other than those prefaced by this term can also be present. The terms ‘comprise’ and ‘comprises’ are to be interpreted in a similar manner.

As used herein, the term ‘(s)’ following a noun means the plural and/or singular form of that noun.

As used herein, the term ‘and/or’ means ‘and’ or ‘or’, or where the context allows both.

Where specific integers are mentioned herein which have known equivalents in the art to which this invention relates, such known equivalents are deemed to be incorporated herein as if individually set forth.

### Security Document or Token

As used herein, the term ‘security documents’ and ‘security tokens’ includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

### Security Device or Feature

As used herein, the term ‘security device’ or ‘security feature’ includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

### Substrate

As used herein, the term ‘substrate’ refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET), biaxially-oriented polypropylene (BOPP); or a composite material of two or more materials, such as a laminate of paper and at least one plastic material, or of two or more polymeric materials.

### Transparent Windows and Half Windows

As used herein, the term ‘window’ refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a ‘half-window’, may be formed in a polymeric security document which has opacifying layers on both sides by omitting the opacifying layers on one side only of the security document in the window area so that the ‘half-window’ is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

### Opacifying Layers

As used herein, the term ‘opacifying layer’ refers to a layer that may be applied to a transparent substrate to increase the opacity of the security document. An opacifying layer is such that LT<L0, where L0 is the amount of light incident on the document, and LT is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### Diffractive Optical Elements (DOEs)

As used herein, the term ‘diffractive optical element’ refers to a numerical-type diffractive optical element (DOE). Numerical-type DOEs rely on the mapping of complex data that reconstruct in the far field (or reconstruction plane) a two-dimensional intensity pattern. Thus, when substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field).

DOEs are sometimes referred to as computer-generated holograms, but they differ from other types of holograms, such as rainbow holograms, Fresnel holograms and volume reflection holograms.

### Optically Variable Device or Image

As used herein, the term ‘optically variable device (OVD)’ or ‘optically variable image’ refers to a security feature or device that changes in appearance. OVDs provide an optically variable effect when the banknote is tilted and/or when the viewing angle of the observer relative to the OVD changes. The image of an OVD may also be changed by aligning a verification device over the security feature or device. An OVD may be provided by a printed area, eg an area printed with metallic inks or iridescent inks, by an embossed area, and by a combination of a printed and embossed feature. An OVD may also be provided by a diffractive device, such as a diffraction grating or a hologram and may include arrays of microlenses and lenticular lenses.

The invention consists in the foregoing and also envisages constructions of which the following gives examples only.

### BRIEF DESCRIPTION OF THE DRAWINGS

The invention will now be described, by way of non-limiting examples, with reference to the accompanying drawings, in which:

FIG. 1 shows a cross-sectional view of a security document according to one embodiment of the present invention;

FIG. 2 shows a front view of the security document of FIG. 1;

FIG. 3 shows a rear view of the security document of FIG. 1;

FIG. 4 shows a cross-section view of a security document where the half-window regions are not in register with each other;

FIG. 5 shows a front view of the security document of FIG. 4;

FIG. 6 shows a cross-section view of a security document where the half-window regions are not in register with each other; and

FIG. 7 shows a front view of the security document of FIG. 6.

### DETAILED DESCRIPTION OF PREFERRED EMBODIMENTS

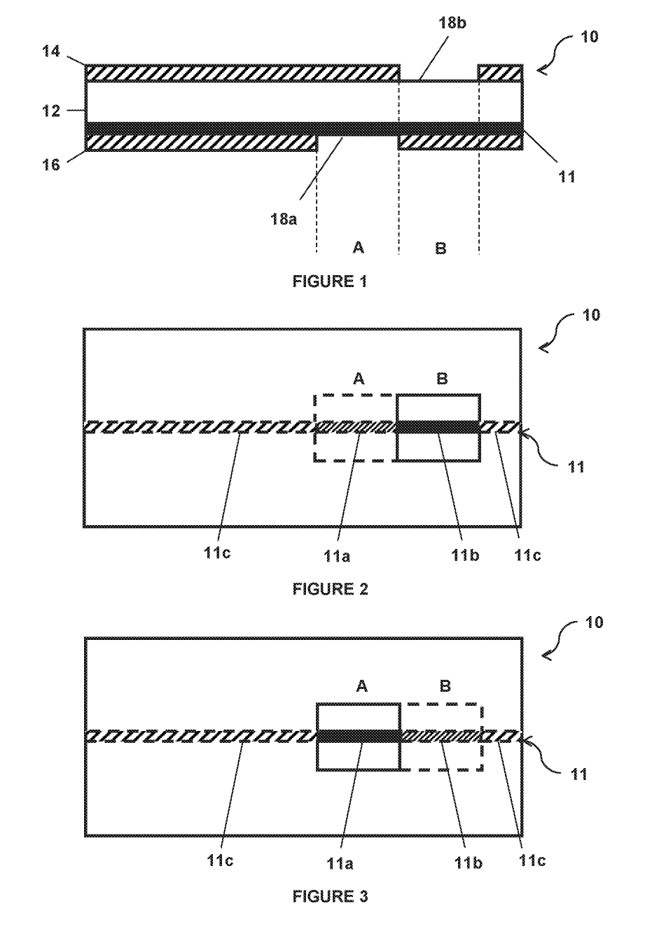

Referring to FIG. 1, a security document 10 according to an embodiment of the present invention comprises a substrate 12 and opacifying layers 14, 16. The security document 10 further comprises a security element 11. The security document is preferably a banknote. The security document may alternatively be a credit card; cheque; passport; identity card; security and share certificate; driver's license; deed of title; travel document; entrance document, birth, death or marriage certificate; and academic transcript.

The substrate 12 is an optically transparent material. The substrate 12 may be formed from a plastic or polymeric material. The substrate may for example be formed from polypropylene (PP), polyethylene (PE), polycarbonate (PC), polyvinyl chloride (PVC), polyethylene terephthalate (PET), biaxially-oriented polypropylene (BOPP). Alternatively, the substrate 12 may be formed from a substantially opaque material, such as paper or fibrous material, with one or more inserts of transparent plastics material, the or each insert being inserted into a cut-out, or recess in the paper or fibrous substrate. The substrate 12 may also include a composite material of two or more materials, such as a laminate of paper and at least one plastic material, or of two or more polymeric materials.

The substrate 12 has a first surface and an opposite second surface. The first surface of the substrate 12 may be the front surface of the substrate, while the second surface of the substrate 12 may be the rear (or back) surface of the substrate. A first opacifying layer 14 is applied to the entire first surface of the substrate 12, except for an optically transmissive area 18b of the substrate 12. A second opacifying layer 16 is applied to the entire second surface of the substrate 12, except for an optically transmissive area 18a of the substrate 12.

As shown in FIG. 1, an edge of the uncovered optically transmissive area 18b on the first surface of the substrate lies directly above an edge of the uncovered optically transmissive area 18a on the second surface of the substrate 12. The uncovered area 18a of the first surface does not substantially overlap the uncovered area 18b of the second surface. That is, neither one of the uncovered areas 18a, 18b can be seen through the other uncovered area. Looking through either of the uncovered areas 18a, 18b would reveal the opacifying layer on the other side and, if present, a, or at least a portion of a, security device.

From the front and rear views of the security document 10, shown in FIGS. 2 and 3 respectively, it can be seen that the first uncovered area 18a and second uncovered area 18b appear to be substantially contiguous when viewed in transmitted light. In particular, under transmitted light, the first uncovered area 18a appears to share a common border with, be touching, or be adjacent to the second uncovered area 18b. The uncovered areas appear to be contiguous within a range of predefined viewing angles. Preferably, the predefined viewing angle includes a viewing angle that is at substantially a normal to the first and second surfaces. That is, the predefined viewing angle includes a viewing angle that is generally perpendicular to the first or second surfaces. The range of predefined viewing angles is preferably between about −60° and about +60° to the normal of the first and second surfaces. More preferably, the range of predefined viewing angles is between about −45° and about +45° to the normal of the first and second surfaces. Even more preferably, the range of predefined viewing angles is between about −10° and about +10° to the normal of the first and second surfaces.

FIGS. 1 to 3 show the first surface and second surface of the substrate 12 each comprise an area that is not covered by an opacifying layer. According to other embodiments of the invention, the first and/or second surfaces of the substrate can comprise more than one area that is not covered by an opacifying layer. Where the first and/or second surfaces of the substrate comprise more than one uncovered area, the uncovered area(s) of the first surface does not substantially overlap the uncovered area(s) of the second surface. Where the first and/or second surfaces of the substrate comprise more than one uncovered area, the first uncovered area(s) and second uncovered area(s) appear to be substantially contiguous when viewed in transmitted light.

This arrangement results in a first half-window region A with an uncovered area 18a on the second surface of the substrate 12 and covered area on the first surface of the substrate 12, and a second half-window region B with an uncovered area 18b on a first surface of the substrate 12 and covered area on the second surface of the substrate 12. The half-window regions A, B are in register with each other. The first half-window region A does not substantially overlap the second half-window region B. Further, there is substantially no space between the first and second half-window regions A, B. The half-window regions A, B are substantially contiguous. The first half-window region A appears to share a common border with, be touching, or be adjacent to the second half-window region B.

Portions of a security device that are present in the half-window regions A, B will have different levels of visibility depending on which side of the document the security device is viewed from. A security device in or on the substrate in the half window regions A, B will appear more clearly in the first half-window region A compared to the second half-window region B when the security document 10 is viewed from the rear (FIG. 3). Conversely, a security device placed in or on the substrate in the half window regions A, B will appear more clearly in the second half-window region B compared to the first half-window region A when the security document 10 is viewed from the front (FIG. 2). The security device can be seen through the uncovered area 18b on the first surface against the opacifying layer 16 on the second surface in the second window region B. The security device can be seen through the uncovered area 18a on the second surface against the opacifying layer 14 on the first surface.

The security document 10 comprises a security device 11 in the substrate 12. The security device 11 may additionally or alternatively be on the substrate 12. The security device 11 may be sandwiched between the optically transmissive region and the opacifying layer on the second surface.

The security device 11 is shown in the form of a security thread. The security device 11 may additionally or alternatively comprise one or more of fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; and/or optically variable devices (OVDs) such as diffractive devices including diffraction gratings, holograms and diffractive optical elements (DOEs). As shown in FIG. 1, the security thread extends the length of the substrate 12. In other embodiments, the security thread or any other security device 11 does not extend the length of the security document and is only present in at least the uncovered optically transmissive areas 18a, 18b of the substrate 12.

The security device that is viewable in the first window region A is preferably of the same type as the security device that is viewable in the second window region B, which is a security thread. In other embodiments, the security device that is viewable in the first window region A may be different from the security device that is viewable in the second window region B.

The security device 11 is shown to extend to areas of the substrate 12 outside the half-window regions A, B where the first and second surfaces are both covered by an opacifying layer 14, 16. The portions 11c of the security device 11 that extend beyond the half-window areas A, B are more visible in transmitted light than in reflected light. The portions 11c of the security device 11 outside the half-window regions A, B are not as visible compared to the portions 11a, 11b of the security device 11 in the half-window regions A, B.

The security device 11 is shown to be embedded in the second surface of the substrate 12. According to other embodiments, the security device is in the first surface or the substrate. According to other embodiments, the security device is in the first and second surfaces of the substrate. According to still other embodiments, the security device is on the first and/or second surfaces of the substrate.

As shown in FIG. 2, from a front view of the security document 10, a portion 11b of the security device 11 is viewable through the uncovered area 18b on the first surface against the opacifying layer 16 on the second surface in the second half-window region B. A portion 11a of the security device 11 can be seen in transmitted light in the first half-window region A, although not as clearly as the portion 11b of the security device 11 in the second half-window region B. Portions 11c of the security device 11 that lie outside the half-window regions A, B can also be seen in transmitted light, although less clear compared to the portion 11a of the security device 11 in the first half-window region A and even less clear compared to the portion 11b of the security device 11 in the second half-window region B.

As shown in FIG. 3, from a rear view of the security document 10, a portion 11a of the security device 11 is viewable through the uncovered area 18a on the second surface against the opacifying layer 14 on the first surface in the first half-window region A. A portion 11b of the security device 11 can be seen in transmitted light in the second half-window region B, although not as clearly as visibility of the portion 11a of the security device 11 in the first half-window region A. Portions 11c of the security device 11 that lie outside the half-window regions A, B can also be seen in transmitted light, although less clear compared to the visibility of the portion 11b of the security device 11 in the second half-window region B and even less clear compared to the visibility of the portion 11a of the security device 11 in the first half-window region A.

The security document 10 is manufactured in such a way that that the first half-window region A and second half-window region B are in register with each other. That is, when the security document 10 is viewed in transmitted light, the first and second half-window regions appear to be adjacent to each other. In particular, an edge of the first half-window region A lies directly below an edge of the second half-window region B such that it appears that the two half-window regions are touching each other in transmitted light.

The method of manufacturing the security document according to an embodiment of the present invention comprises the steps of:

providing a substrate comprising an optically transmissive region;
applying a first opacifying layer on a first surface of the substrate including a portion of the optically transmissive region with an area of the optically transmissive region not being covered by the first opacifying layer; and
applying a second opacifying layer on a second surface of the substrate including a portion of the optically transmissive region, the second surface being on an opposite side of the substrate to the first surface, with an area of the optically transmissive region not being covered by the second opacifying layer.

The uncovered area of the first surface does not substantially overlap the uncovered area of the second surface. The first uncovered area and second uncovered area appear to be substantially contiguous when viewed in transmitted light.

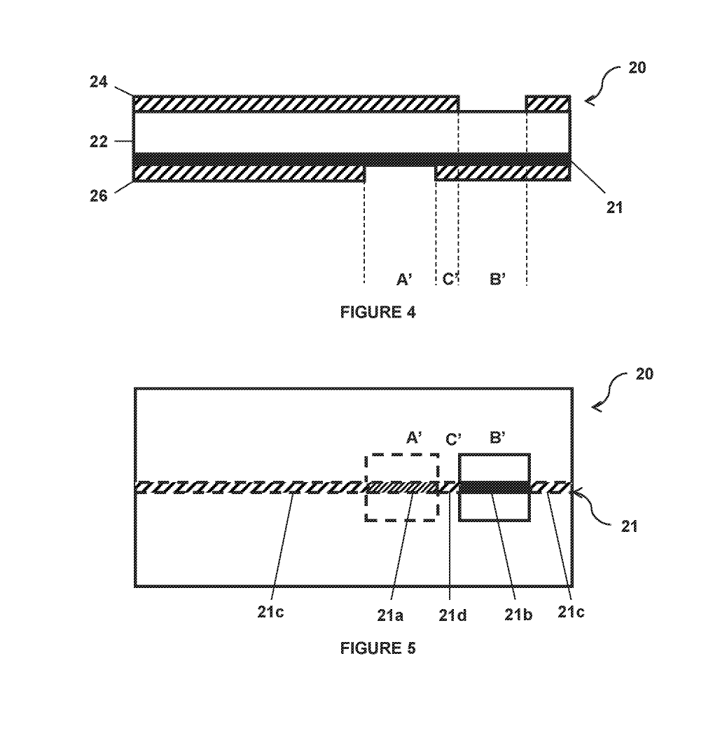

Referring to FIGS. 4 and 5, if there is a substantial region between the first half-window region A′ and second window region B′ where an opacifying layer is provided on the first and second surfaces of the substrate, the first half-window region A′ and the second half-window region B′ are not said to be in register with each other. In this configuration, the first half-window region A′ will appear to be spaced apart from the second half-window region B′ by an opaque region C′ when viewed in transmitted light. In the opaque region C′, the first and second surfaces of the substrate 22 are covered by an opacifying layer 24, 26. When viewing the front of the security document in transmitted light, a portion 21b of the security device 21 will be clearly visible in the second half-window region B′. A portion 21a of the second security device 21 will be less visible in the first half-window region A′. A portion 21d of the security device 21 will be even less visible in the opaque region C′, and will have the same level of visibility as the portions 21c of the security device 21 outside the window areas. A person viewing the document 20 with the security device 21 will therefore be able to detect a counterfeit document which does not have accurate registration between the edges of the half-window regions A′ and B′ by the presence of the portion 21d of the security device 21 between the half-window regions A′ and B′.

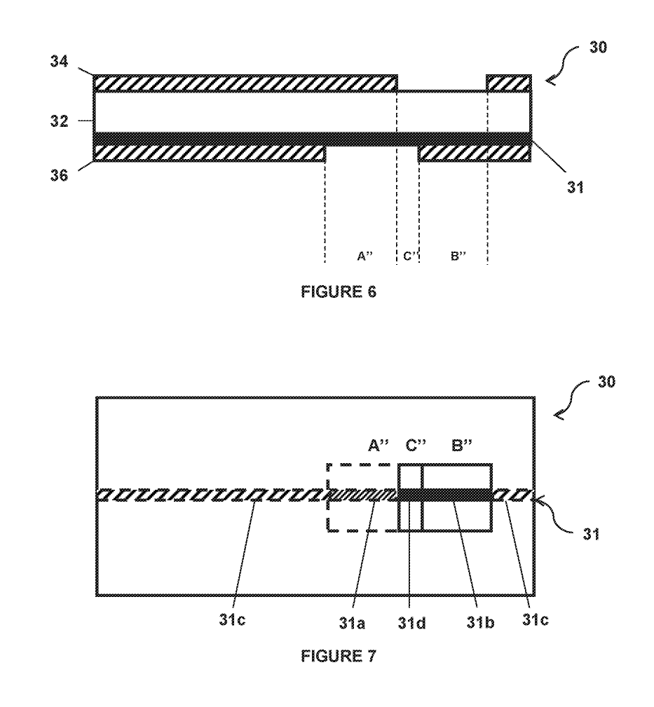

If there is substantial overlap between the first half-window region and the second half-window region as shown in FIGS. 6 and 7, the first half window region A″ and the second half-window region B″ are not said to be in register with each other. In this configuration, the first half-window region A″ will appear to be spaced apart from the second half-window region B″ by a window region C″ when viewed in transmitted light. In these figures, an edge of the half-window region A″, B″ on one surface of the substrate 32 falls above or below an uncovered region of the substrate 32 on the other surface to form a full-window region C″. In the full-window region C″, a portion 31d of the security device 31 can be seen without an opacifying layer behind it. When viewing the front of the security document 30 in transmitted light, a portion 31b of the security device 31 will be clearly visible in the second half-window region B″ against an opacifying layer. A portion 31a of the security device 31 will be less visible in the first half-window region A″, and portions 31c of the security device 31 outside the half-window regions A″ and B″ and the full-window region C″ will be even less visible.

Therefore, a person viewing the document 30 with the security device 31 will be able to detect a counterfeit document which does not have accurate registration between the edges of the half-window regions A″ and B″ by the presence of the full-window region C″ and the portion 31d of the security device 31.

Preferred embodiments of the invention have been described by way of example only and modifications may be made thereto without departing from the scope of the invention.

Other modifications and embodiments include those described in the Summary of the Invention section.

1. A method of manufacturing a security document, the method comprising the steps of:
providing an optically transmissive region;
applying a first opacifying layer on a portion of a first surface of the optically transmissive region with an area on the first surface of the optically transmissive region not being covered by the first opacifying layer; and
applying a second opacifying layer on a portion of a second surface of the optically transmissive region, the second surface being on an opposite side of the optically transmissive region to the first surface, with an area on the second surface of the optically transmissive region not being covered by the second opacifying layer;
wherein an edge of the uncovered area of the first surface is in accurate registration with an edge of the uncovered area of the second surface such that the uncovered area of the first surface does not substantially overlap the uncovered area of the second surface, and the uncovered area of the first surface and uncovered area of the second surface appear to be substantially contiguous when viewed in transmitted light.

2. The method according to claim 1, further comprising providing a security device on or in the optically transmissive region, a portion of the security device being viewable through the uncovered area on the first surface against the opacifying layer on the second surface and a different portion of the security device being viewable through the uncovered area on the second surface against the opacifying layer on the first surface.

3. The method according to claim 1 comprising providing a first security device on or in the optically transmissive region that is viewable through the uncovered area on the first surface and providing a second security device on or in the optically transmissive region that is viewable through the uncovered area on the second surface.

4. The method according to claim 3, wherein the first security device and the second security device are of the same type, or the first security device is different from the second security device.

5. The method according claim 2, wherein the security device that is viewable through the uncovered area on the first surface is sandwiched between the optically transmissive region and the opacifying layer on the second surface and/or the security device that is viewable through the uncovered area on the second surface is sandwiched between the optically transmissive region and the opacifying layer on the first surface.

6. The method according to claim 5, wherein the security device that is viewable through the uncovered area on the first surface is on the uncovered area of the first surface and/or the security device that is viewable through the uncovered area on the second surface is on the uncovered area of the second surface.

7. The method according to claim 1, wherein the first surface of the optically transmissive region comprises more than one area that is not covered by the first opacifying layer, and/or the second surface of the optically transmissive region comprises more than one area that is not covered by the opacifying layer.

8. The method according to claim 7, wherein the uncovered area(s) of the first surface and the uncovered area(s) of the second surface appear to be substantially contiguous when viewed in transmitted light within a range of predefined viewing angles.

9. The method according to claim 8, wherein the predefined viewing angle includes a viewing angle that is at substantially a normal to the first and second surfaces.

10. The method according to claim 8, wherein the range of predefined viewing angles is between about −60° and about +60° to the normal of the first and second surfaces, or between about −45° and about +45° to the normal of the first and second surfaces, between about −10° and about +10° to the normal of the first and second surfaces.

11. A security document when manufactured by the method of claim 1.

12. A security document comprising:
an optically transmissive region having first and second surfaces on opposite sides of the optically transmissive region,
a first layer of opacifying ink on a portion of the first surface of the optically transmissive region, with an area of the optically transmissive region not being covered by the first layer of opacifying ink, and
a second layer of opacifying ink on a portion of the second surface of the optically transmissive region, with an area of the optically transmissive region not being covered by the second layer of opacifying ink,
wherein an edge of the uncovered area of the first surface is in accurate registration with an edge of the uncovered area of the second surface such that the uncovered area of the first surface does not substantially overlap the uncovered area of the second surface, and the uncovered area of the first surface and uncovered area of the second surface appear to be substantially contiguous when viewed in transmitted light.

13. The security document according to claim 12, further comprising a security device on or in the optically transmissive region, a portion of the security device being viewable through the uncovered area on the first surface against the opacifying layer on the second surface and a different portion of the security device being viewable through the uncovered area on the second surface against the opacifying layer on the first surface.

14. The security document according to claim 12 comprising a first security device on or in the optically transmissive region that is viewable through the uncovered area on the first surface and a second security device on or in the optically transmissive region that is viewable through the uncovered area on the second surface.

15. The security document according to claim 14, wherein the first security device and the second security device are of the same type, or the first security device is different from the second security device.

16. The security document according to claim 12, wherein the security device that is viewable through the uncovered area on the first surface is sandwiched between the optically transmissive region and the opacifying layer on the second surface and/or the security device that is viewable through the uncovered area on the second surface is sandwiched between the optically transmissive region and the opacifying layer on the first surface.

17. The security document according to claim 16, wherein the security device that is viewable through the uncovered area on the first surface is on the uncovered area of the first surface and/or the security device that is viewable through the uncovered area on the second surface is on the uncovered area of the second surface.

18. The security document according to claim 12, wherein the first surface of the optically transmissive region comprises more than one area that is not covered by the first opacifying layer, and/or the second surface of the optically transmissive region comprises more than one area that is not covered by the opacifying layer.

19. The security document according to claim 12, wherein the uncovered area of the first surface and the uncovered area of the second surface appear to be substantially contiguous when viewed in transmitted light within a range of predefined viewing angles.

20. The security document according to claim 19, wherein the predefined viewing angle includes a viewing angle that is at substantially a normal to the first and second surfaces, or between about −60° and about +60° to the normal of the first and second surfaces, or between about −45° and about +45° to the normal of the first and second surfaces, or between about −10° and about +10° to the normal of the first and second surfaces.

21. (canceled)
